(19) United States
(12) Patent Application Publication
(10) Pub. No.: US 2014/0062390 A1
(43) Pub. Date: Mar. 6, 2014

(54) USB POWER SHELF

(71) Applicant: Reid Wallace Webber, Apo (AE)

(72) Inventor: Reid Wallace Webber, Apo (AE)

(21) Appl. No.: 14/012,267

(22) Filed: Aug. 28, 2013

Related U.S. Application Data
(60) Provisional application No. 61/695,061, filed on Aug. 30, 2012.

(51) Int. Cl. H02J 7/00

(52) U.S. Cl. CPC H02J 7/0042
USPC 320/107

(57) ABSTRACT

A storage system with plurality of USB powered ports for charging multiple electronic devices. The invention provides a stable platform with various sized shelves and downstream powered USB ports to charge and network multiple electronic devices. The primary power management and voltage distribution system provides connectivity from a single 120-240 volt power cable to multiple USB ports. The USB ports provide standard power and data transmission capability for connected devices creating an integrated network and storage system for multiple electronic devices.

### CROSS-REFERENCE TO RELATED APPLICATIONS

This Application claims the benefit of U.S. Provisional Application 61/695,061 filed on Aug. 30, 2012.

### FIELD OF THE INVENTION

The invention is a shelving system which includes a charging system for electronic devices.

### BACKGROUND OF THE INVENTION

The present invention pertains to a device that creates a storage system for multiple electronic devices with integrated USB docking ports for charging and networking.

Today's technology savvy generation has accumulated numerous electronic gadgets, from computers, cell phones, and the like. Each of these electronic devices requires a power charger, generally a bulky, heavy transformer followed by a long cord that connects the device to a wall outlet.

Multiple devices create a challenge for a limited number of power outlets available in homes and businesses. Philip Labre invented and patented the current electrical outlet in 1927. There are two standards used worldwide, North American 120 volts and European 220-240 volts, and 24 types of outlets. To meet the growing number of relatively small electronic devices, users typically add multiple power strips, which increase the risk of fire hazards.

The invention creates a storage solution with charging capability for multiple electronic devices. The invention includes various sized shelves and storage systems to support and display various handheld electronic devices. A single electrical outlet provides power to the invention to recharge and power all connected electronic devices.

The invention utilizes Universal Serial Bus (USB) ports to provide power to the electronic devices. The USB, developed in the mid-1990s, is currently the standard for most common computer connection for electronic devices throughout the world; however, most USB connectors support downstream data flow and can only charge one device at a time. The invention includes multiple USB powered ports to provide power to the attached devices.

### SUMMARY OF THE INVENTION

The invention is a shelving and electronic system to provide power and storage for multiple electronic devices. The storage system is composed of a support system and various shelves to create a stable platform for multiple small, handheld devices. The invention has multiple USB powered ports to charge attached electronic devices resting on the shelves. The system manages current, voltage distribution, and control of networked devices. The invention uses a single wall outlet with dual voltage capability. The plurality of USB ports enable a wide range of various devices to be charged such as cell phones, eReaders, electronic frames, cameras, video camera and common household devices such as lights and clocks. The invention has two primary components: the support system and the electronic system.

The invention's support system provides a secure platform composed of a support and shelves adjustably mounted to the support. The support holds the electronic components and provides support and attachment for multiple shelves. The shelves provide storage space for various electronic devices and objects.

The electronic system includes a power distribution hub, an electric power cord and USB connectors. The power cord connects the hub to an AC power outlet. The hub distributes power to each of the USB power ports.

The invention has a wide variety of options and combinations. The initial invention will be secured to the floor or a wall for stability, but plans envision stand-alone systems. The invention uses USB connectors to create an open architecture for the widest variety of electronic devices. The goal is to enable users to use existing USB enabled devices to connect to Wi-Fi networks.

### BRIEF DESCRIPTION OF THE DRAWINGS

FIG. 1 illustrates the ¾ frontal perspective of the invention showing the support system, shelves and USB ports in accordance with the principles of the present invention;

FIG. 2 is a fragmentary view of the support system shown in FIG. 1 rotated 90 degrees to show that the front and back of the support system are substantially identical;

FIG. 3 illustrates a fragmentary perspective view of the invention depicting the electronic system with a power distribution hub and USB cables in accordance with the principles of the present invention;

FIG. 4 illustrates a fragmentary frontal view of the invention with various electronic devices such as cell phones, electronic frames, lights and RC toys in accordance with the principles of the present invention; and

FIG. 5 illustrates a frontal elevational view of the present invention.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

Is should be further understood that the title of this section of this specification, namely, “Detailed Description Of The Preferred Embodiments” relates to a requirement of the United States Patent Office, and does not imply, nor should it be inferred to limit the subject matter disclosed herein.

The invention incorporates the current standards for USB technology to create an interactive storage and electronic shelving system. The invention will adapt to new technology and add capability to support various electronic devices, such as HDMI, Ethernet, Firewire and other future developments.

The invention has two main components: a support system 10 and an electronic system 30.

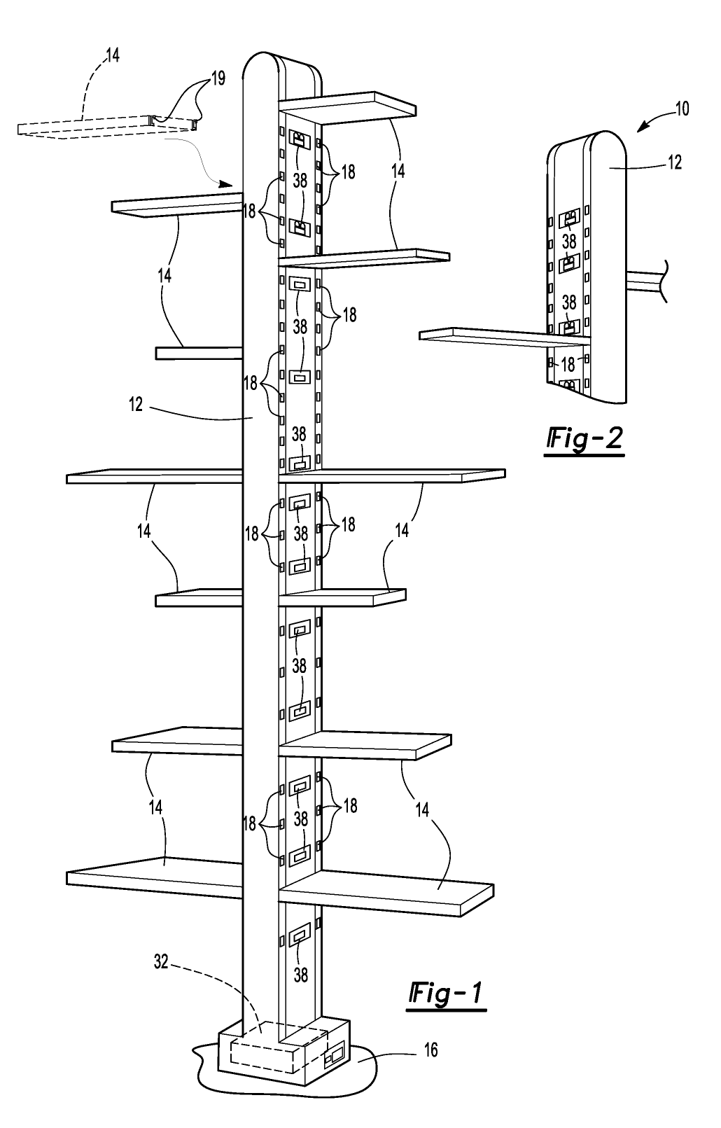

Referring to FIG. 1 and FIG. 2 the support system 10 is composed of a support 12 and shelves 14 to create a stable platform for various electronic devices and objects 15 (FIG. 4). The support 12 is anchored to the wall or the floor 16 and, as best seen in FIG. 5, houses the electronic system 30. As shown in FIG. 1 and FIG. 2, the support 12 has a series of slots 18 for various types of shelves 14 and USB port outlets 38 to connect to electronic devices 15. The shelves 14 include male brackets 19 which are insertable in the slots 18 to adjustably mount the shelves 14 to the support 12.

While the support system 10 includes features that will enable space saving and decorative options, future designs can be envisioned to support a variety of styles for locations throughout the home and offices.

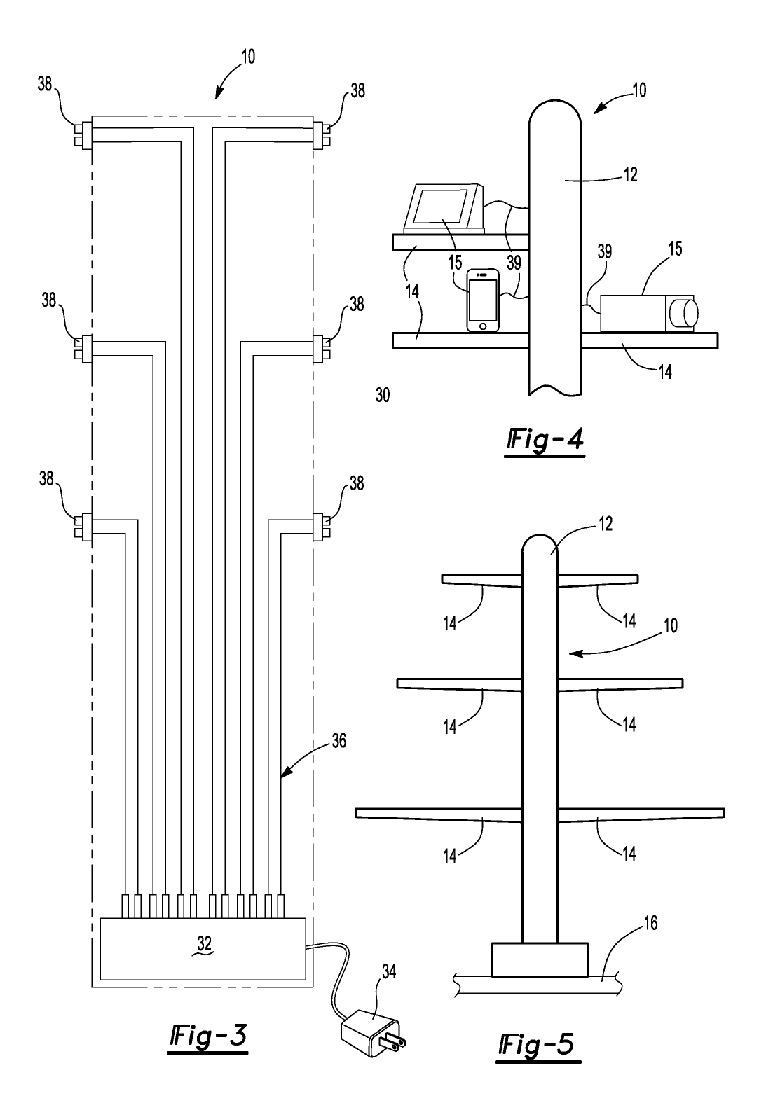

As best seen in FIG. 3 the electronic system 30 includes a power hub 32, an AC power cord 34 and USB powered cables 36. The power hub 32 and the USB cables 36 are housed within the support 12 and the AC power cord 34 connects the power hub 32 to a standard upstream outlet (not shown) 35 100-240 V, 50/60 Hz to support both North American and European electrical standards. As shown in FIG. 3, the power hub 32 distributes power through the USB cables 36 to multiple USB ports 38 positioned in and throughout the support 12 providing connectivity and power to the USB ports 38. The electronic devices 15 can be stored on a shelf 14 and if needed selectively charged by connection to one of the USB ports 38 through cables 39. FIG. 1 and FIG. 2 show 24 downstream USB ports 38 providing the current standard 500 mA each and a transfer speed of up to 5 Gbps.

It is apparent that the present invention provides a solution for storing and charging the multiple electronic devises that now are a part of everyone's daily life. The electronic system is housed almost entirely within the support of the support system so as not to detract from the decorative features of the support system enabling it to fit the decor of the home or office.

1. A support system for supporting a number of electronic devices and an electronic system for selectively charging the electronic devices, the support system comprising;
a support and shelves adjustably mounted to said support; and
said electronic system including charging outlets mounted in spaced positions on said support and electrical cables providing an electrical charge to said charging outlets to charge said electronic devices.

2. The system in accordance with claim 1 wherein: the support system comprises said support and various types of said shelves mounted to said support to provide a stable storage platform.

3. The system in accordance with claim 1 wherein: charging outlets of said electronic system are USB ports.

4. The system in accordance with claim 3 wherein: the electronic system comprises a hub disposed within said support and providing power to said USB ports.

5. The system in accordance with claim 1 wherein said electronic system is housed within said support.
